(19) United States
(12) Patent Application Publication
(10) Pub. No.: US 2025/0012188 A1
(43) Pub. Date: Jan. 9, 2025

(54) DUST MITIGATION SYSTEM

(71) Applicant: Epiroc Drilling Solutions, LLC, Garland, TX (US)

(72) Inventors: Mahmood Hassan, Garland, TX (US); Austen Whitaker, Garland, TX (US)

(21) Appl. No.: 18/762,889

(22) Filed: Jul. 3, 2024

Related U.S. Application Data
(60) Provisional application No. 63/525,319, filed on Jul. 6, 2023.

(51) Int. Cl. E21C 35/22; B08B 5/02; B08B 13/00

(52) U.S. Cl. CPC E21C 35/22; B08B 5/02; B08B 13/00

(57) ABSTRACT

A dust mitigation system removes dust from the lens of a laser or a camera on a mining equipment rig or in other industrial applications. The dust mitigation system is operable to deliver high pressure air in short bursts to remove dirt from the lens in a manner that does not damage the laser or the camera.

### CROSS-REFERENCE TO RELATED APPLICATIONS

This application claims priority to, and the benefit of, U.S. Provisional Patent Application Ser. No. 63/525,319 filed Jul. 6, 2023, and entitled “Dust Mitigation System,” the disclosure of which is incorporated herein by reference in its entirety.

### TECHNICAL FIELD

The present disclosure relates to dust mitigation systems and associated methods for removing dust from the lenses of lasers or cameras on mining equipment rigs or in other industrial applications.

### BACKGROUND

A mining equipment rig may include a plurality of lasers and/or a plurality of cameras for autonomous operation of the rig. These lasers and/or cameras may be placed anywhere on the rig. Due to the harshness of mining environments, these lasers and/or cameras often get covered in dust from drilling and other conditions, impairing their functionality and potentially interrupting the autonomous operation of the mining equipment. One conventional method for correcting this problem involves mine personnel manually cleaning the lenses on the lasers and/or cameras, such as by wiping the lenses clean. This manual cleaning method is inefficient and can potentially cause damage to the lasers and/or cameras.

### SUMMARY

The present disclosure relates to dust mitigation systems and associated methods for removing dust from the lenses of lasers and/or cameras on mining equipment rigs or in other industrial applications.

In various implementations, the dust mitigation systems are operable to deliver high pressure air in short bursts to remove dirt from the lenses of lasers and/or cameras in a manner that does not damage the lasers and/or cameras.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 is a side view of an implementation of a dust mitigation system according to the present disclosure.

FIG. 2 is a schematic view of the dust mitigation system of FIG. 1 operatively coupled to a representative laser, according to the present disclosure.

FIG. 3A is an enlarged front view of a laser housing to which a dust mitigation system is coupled to clean a laser lens disposed within the laser housing.

FIG. 3B is an enlarged side view of the laser housing and dust mitigation system shown in FIG. 3A.

Like reference symbols in the various drawings indicate like elements.

### DETAILED DESCRIPTION

The present disclosure relates to dust mitigation systems and associated methods for removing dust from the lenses of lasers and/or cameras on mining equipment rigs or in other industrial applications. The dust mitigation systems of the present disclosure may be automated or semi-automated to facilitate dust removal at regular intervals or at certain stages of operation without the direct involvement of mine personnel and without interfering with autonomous operations of the mining equipment rigs.

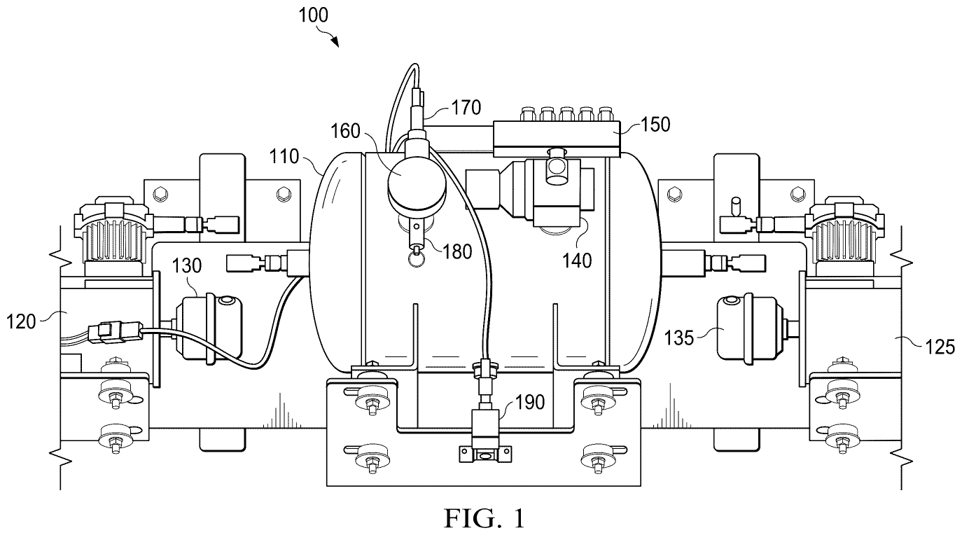

Referring now to FIG. 1, in an implementation, a dust mitigation system 100 of the present disclosure comprises an air tank 110 that receives compressed air from one or more compressors 120, 125. In some implementations, the air tank 110 is a 5-gallon air tank, and the dust mitigation system 100 includes two compressors 120, 125 that operate in tandem to quickly fill the air tank 110 to a desired pressure without requiring continuous operation of the compressors 120, 125. In some implementations, the compressors 120, 125 are oil-less.

Air filters 130, 135 are disposed on the air intake side of each of the air compressors 120, 125, respectively, to filter dust and dirt out of the ambient air before it enters the compressors 120, 125. The media in the air filters 130, 135 is replaceable, and in some implementations, the media is washable for re-use. In some implementations, the media should be changed every 1,000 hours of operation, or sooner if needed.

Pressure within the air tank 110 may be monitored by a pressure gauge 160 with a visual readout and a pressure switch 170 set to indicate when the compressors 120, 125 should be turned on and off based on the pressure within the air tank 110. In some implementations, if the tank pressure is less than or equal to approximately 110 pounds per square inch (psi), the compressors 120, 125 are turned on, and when the tank pressure reaches approximately 145 psi, the compressors 120, 125 are turned off.

A pressure relief valve 180 is operable to bleed pressure from the air tank 110, either manually by mine personnel, or automatically if the pressure exceeds an upper limit set point. In some implementations, the upper limit set point is approximately 150 psi, which is the pressure at which when the pressure relief valve 180 opens to bleed pressure from the air tank 110.

An air dump solenoid valve 190 may be provided at or near the bottom of the air tank 110 to enable periodic removal of the air contained within the air tank 110, as well as any water that may have condensed out of the air contained in the air tank 110. In some implementations, the air dump solenoid 190 is opened approximately every 12 hours.

The air tank 110 is coupled to a pressure regulator 140, which regulates the pressure of the air flowing out of the air tank 110. The output of the pressure regulator 140 is coupled to a manifold 150 that splits the regulated air into a plurality of ports, each coupled to a separate air flow line 155 that routes regulated air to a separate device on the mining equipment rig. A representative mining equipment rig may include 5-7 lasers disposed around the periphery of the rig for obstacle detection during autonomous tramming. In addition, a representative mining equipment rig may include a plurality of cameras positioned to assist with other autonomous or semi-autonomous operations, such as leveling, drilling, and de-leveling, for example. The number of ports in the manifold 150 corresponds to the number of lasers, cameras, or other devices to which regulated air will be routed for dust removal. In some implementations, the pressure regulator 140 regulates the pressure of the air flowing out of the air tank 110 down to approximately 110 psi, and air in the range of 100-110 psi is required to clean the lens of a device.

For cold weather environments, the dust mitigation system 100 of the present disclosure may optionally include heaters installed on the various valves, tubing, and air tank.

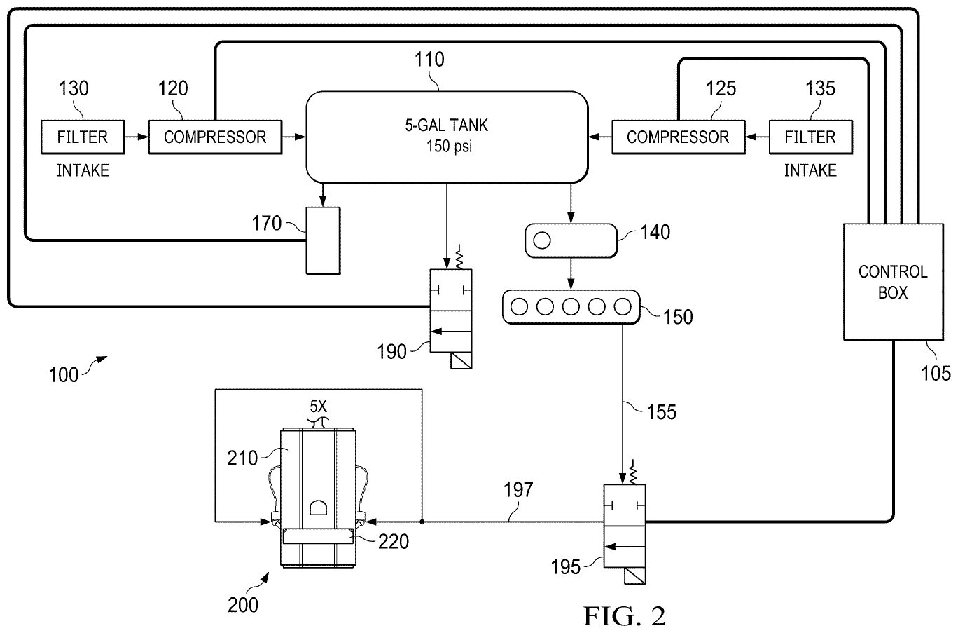

FIG. 2 depicts a schematic view of a representative operational environment in which the dust mitigation system 100 of FIG. 1 is coupled to a laser 200 to clean a laser lens 220 disposed within a laser housing 210. A control box 105 houses equipment that functions to control the operation of the dust mitigation system 100. In the schematic of FIG. 2, electrical cables to and from the control box 105 are represented in blue lines. In some implementations, the control box 105 houses one or more timers, an on/off switch to enable/disable the dust mitigation system 100, and a stand-alone programmable logic controller (PLC) to control the operation of the dust mitigation system 100. A mining equipment rig control system may be used to control the operation of the dust mitigation system 100 instead of the stand-alone PLC. The on/off switch may be used to disable the dust mitigation system 100 to perform maintenance, replace components, upgrade the system, troubleshoot, and for other purposes.

FIG. 2 represents air tubing and components in gray lines. As previously described, the regulated air flows from the pressure regulator 140 into the manifold 150, which splits the regulated air into a plurality of ports, each coupled to a separate air flow line 155 that carries regulated air to a particular device, such as a laser or camera. The air flow line 155 shown in FIG. 2 carries regulated air to the laser 200, and that regulated air is delivered to the laser 200 through a solenoid valve 195. The solenoid valve 195 may be periodically activated based on an adjustable timer in the control box 105, and when the solenoid valve 195 is activated, it opens to deliver short bursts of high pressure air to the laser lens 220, thereby removing dust and dirt without damaging the laser 200. In some implementations, the short bursts of air last approximately 2 seconds, and the timer is set to deliver the short bursts of air every 2 minutes to 5 minutes.

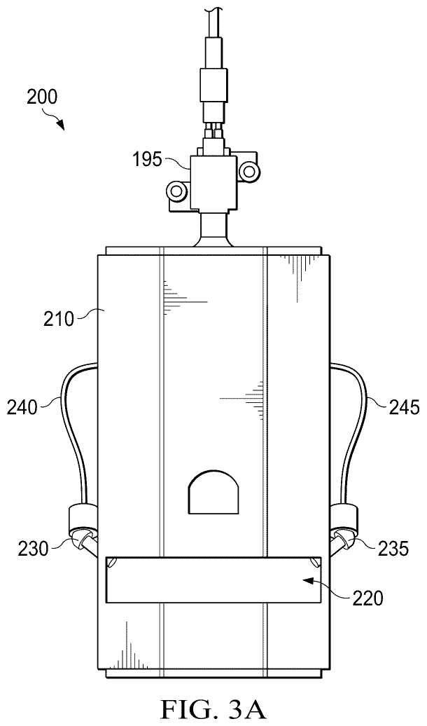

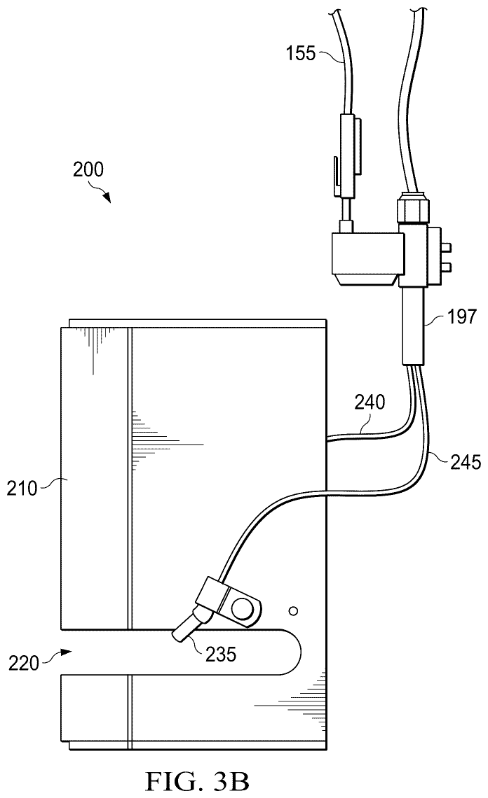

Referring now to FIG. 3A and FIG. 3B, which depict enlarged front and side views of the laser 200, respectively, the outlet of the solenoid valve 195 may be coupled to a flow splitter 197 that divides the regulated air into two air tubes 240, 245, each wrapping around an opposite side of the laser housing 210 and coupling to nozzles 230, 235. These nozzles 230, 235 are pointed toward the laser lens 220 to deliver the short bursts of high pressure air to clean the lens 220. In some implementations, the nozzles 230, 235 may be pointed toward the laser lens 220 at a desired angle to enhance the cleaning operation. In various implementations, the laser lens 220 is flat or convex in shape, and the desired angle ranges from 0 degrees to 45 degrees depending on the shape of the laser lens 220.

In an implementation, power to operate the dust mitigation system 100 may be pulled from the motor starter for the mining equipment rig, such that the dust mitigation system 100 is only operational when the engine is running and the on/off switch is in the “ON” position. The dust mitigation system 100 turns off when the engine is turned off, or if the on/off switch is in the “OFF” position. In other implementations, the dust mitigation system includes its own power supply, such as a battery that charges by solar power, or a battery that charges when the engine of the mining equipment rig is running to enable operation of the dust mitigation system when the engine is not running.

In a representative operational example, a mining equipment rig may autonomously tram to a drilling location, then level up, then perform the drilling operation, then delevel before tramming to a new location. The mining equipment rig may employ cameras during all steps of this operation, while only employing lasers for obstacle detection during tramming. In some implementations, rather than delivering the short bursts of air on a timed interval to clean the lasers, the dust mitigation system 100 may be programmed to deliver short bursts of air while leveling, while deleveling, and/or on demand by mine personnel.

It is to be understood that implementations of the present disclosure are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. For example, the size of the air tank, the number of compressors, the number of manifold ports, the tank pressure set points, the timer durations, the angle of the nozzles, and other system and method modifications are all contemplated within the scope of the present disclosure.

Moreover, the scope of the present application is not intended to be limited to the particular implementations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

1. A dust mitigation system comprising:
at least one compressor configured to deliver compressed air to an air tank;
a pressure regulator configured to regulate the pressure of compressed air flowing out of the air tank; and
at least one air flow line configured to deliver regulated compressed air to remove dust from a lens of a device.

2. The dust mitigation system of claim 1, further comprising:
a manifold operable to split the regulated compressed air into a plurality of ports;
wherein the at least one air flow line comprises a plurality of air flow lines;
wherein each of the plurality of ports is coupled to a separate air flow line of the plurality of air flow lines; and
wherein each separate air flow line is configured to deliver regulated compressed air to remove dust from a lens of a separate device.

3. The dust mitigation system of claim 2, wherein the separate devices consist of lasers or cameras or a combination of lasers and cameras.

4. The dust mitigation system of claim 1, further comprising:
a pressure switch set to indicate when to turn on and off the at least one compressor based on the pressure of compressed air within the air tank.

5. The dust mitigation system of claim 1, further comprising:
a pressure relief valve set to bleed compressed air from the air tank if the pressure of compressed air within the air tank exceeds an upper limit set point.

6. The dust mitigation system of claim 1, further comprising:
an air filter disposed on an intake side of the at least one compressor.

7. The dust mitigation system of claim 1, further comprising:
an air dump solenoid valve operable to enable the removal of air and condensed water from the air tank.

8. The dust mitigation system of claim 1, further comprising:
at least one heater.

9. The dust mitigation system of claim 1, further comprising:
at least one battery that charges using solar power.

10. The dust mitigation system of claim 1, further comprising:
a control system operable to control the operation of the dust mitigation system.

11. The dust mitigation system of claim 10, wherein the control system comprises:
a controller;
a timer; and
an on/off switch.

12. The dust mitigation system of claim 11, wherein the controller is a PLC controller.

13. The dust mitigation system of claim 1, further comprising:
a solenoid valve coupled between the at least one air flow line and the device;
wherein the solenoid valve is periodically activated to deliver regulated compressed air to remove dust from the lens of the device.

14. The dust mitigation system of claim 13, further comprising:
a flow splitter coupled to an outlet of the solenoid valve;
wherein the flow splitter divides and directs the regulated air to a first nozzle and a second nozzle positioned on opposite sides of the lens of the device;
wherein the first nozzle and the second nozzle deliver the regulated compressed air to remove dust from the lens of the device.

15. The dust mitigation system of claim 14, wherein each of the first nozzle and the second nozzle are pointed toward the lens of the device at a desired angle.

16. A mining equipment rig comprising the dust mitigation system of claim 1.

17. The mining equipment rig of claim 16, wherein power to operate the dust mitigation system is pulled from a motor starter of the mining equipment rig.

18. The mining equipment rig of claim 17, wherein the dust mitigation system is operational when an engine of the mining equipment rig is running, and wherein the dust mitigation system turns off when the engine turns off.

19. The mining equipment rig of claim 17, wherein the dust mitigation system further comprises a battery that charges when an engine of the mining equipment rig is running, and wherein the dust mitigation system is powered by the battery when the engine turns off.

20. The mining equipment rig of claim 16, wherein a control system of the mining equipment rig controls the operation of the dust mitigation system.
